(19) United States
(12) Patent Application Publication
(10) Pub. No.: US 2006/0053115 A1
(43) Pub. Date: Mar. 9, 2006

(54) Publicly accessible data method, apparatus and system for electronically distributing performances

(76) Inventor: Durell M. Ashby, Spring, TX (US)

Correspondence Address: Durell M. Ashby, 3410 Hartfield Lane, Spring, TX, 77388, US

(21) Appl. No.: 10/918,266

(22) Filed: Aug. 13, 2004

(51) Int. Cl. G06F 17/30

(52) U.S. Cl. 707/10

(57) ABSTRACT

A publicly accessible data system comprises a database of components that are audio, video, and/or photo, a manipulation module, and a presentation device. The database resides on a server. The manipulation module allows a user to create and/or modify a presentation file that is a subset of the components. The presentation file has at least two components that are audio, video, and/or photo, and that have been merged into the presentation file. The presentation file resides on the server. The presentation device presents the presentation file from the server. The presentation file is presented to the user.

### BACKGROUND OF THE INVENTION

1. Field of the Invention

The present invention relates generally to electronic distribution of performances and, more particularly, to a publicly accessible data method, apparatus and system for electronically distributing performances.

2. Description of Related Art

Sports and music may fairly be described as among America's greatest pastimes. Television ratings testify to America's love of both sports and music. Both cable and satellite television devote several channels to sports, and several channels to music, and both industries provide more than their fair share of celebrities.

The amount of sports footage, like the amount of music that has been recorded, is enormous. With so many players, on so many teams, in so many sports, over so many seasons, much of the sports footage is unavailable to the typical consumer. When sports fans discuss sporting events they have seen, regardless of whether the sporting events were professional, college, high school, or other level, sports fans generally must describe highlights of the sporting events from memory. The retelling can lose much of its immediacy, and be very difficult to describe.

Using video recorders, including digital video recorders, many sports enthusiasts have even collected video clips of their favorite sports teams and events. While some discussions regarding sports occur in private residences, where the Internet may provide some information relevant to the statistics of a particular sporting event, many sports-related conversations among sports fans occur outside the home. Restaurants, sports bars, college campuses, coffee shops, nightclubs, sporting arenas, high schools, and public Internet hot spots are merely a few of the places where consumers may wish there were some way to view a sporting event, as it was recorded. The footage exists. But it has not been available to consumers.

Jukeboxes for audio recordings have been known for decades. Individuals may use coins or dollars to activate a jukebox. The consumers may then select one or more songs to be played from the jukebox, either through the jukebox itself or through loudspeakers attached to the jukebox. Someone other than the consumer, such as the owner of a restaurant where the jukebox is located, generally determines the selection of songs available in the jukebox, and often a particular song desired by the consumer is not available. Consumers have generally not had a way to add songs to the jukebox. This is so, despite the fact that many consumers have purchased DVDs and other digitized musical formats, and have downloaded music from well-known websites.

### SUMMARY OF THE INVENTION

In accordance with one aspect of the present invention, a new and improved publicly accessible data method, apparatus and system for electronically distributing performances is described that substantially departs from the conventional concepts and designs of the prior art, and in doing so provides an apparatus that safely, easily and electronically distributes performances. The publicly accessible data method, apparatus and system for electronically distributing performances has many novel features that are not anticipated, rendered obvious, suggested, or even implied by the prior art, either alone or in any combination.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

Any feature or combination of features described herein are included within the scope of the present invention provided that the features included in any such combination are not mutually inconsistent as will be apparent from the context, this specification, and the knowledge of one of ordinary skill in the art. For purposes of summarizing the present invention, certain aspects, advantages and novel features of the present invention have been described herein. Of course, it is to be understood that not necessarily all such aspects, advantages or features will be embodied in any particular embodiment of the present invention. Additional advantages and aspects of the present invention are apparent in the following detailed description and claims.

### BRIEF DESCIRPTION OF THE FIGURES

The invention will be better understood and objects other than those set forth above will become apparent when consideration is given to the following detailed description thereof. Such description makes reference to the annexed drawings wherein:

FIG. 1 is a schematic diagram depicting a publicly accessible data system 10, in accordance with an exemplary embodiment of the present invention.

FIG. 2 is a flowchart depicting a method in accordance with a second embodiment of the present invention.

### DETAILED DESCRIPTION OF THE EXEMPLARY EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the manufacture of a new and improved publicly accessible data method, apparatus and system for electronically distributing performances. The present invention may be practiced in conjunction with various construction techniques that are conventionally used in the art, and only so much of the commonly practiced process steps are included herein as are necessary to provide an understanding of the present invention. The present invention has applicability in the field of construction in general. For illustrative purposes, however, the following description pertains to a publicly accessible data method, apparatus and system for electronically distributing performances.

Various embodiments of the present invention provide a new and improved publicly accessible data method, apparatus and system for electronically distributing performances that has all or many of the advantages of the prior art and few or none of the disadvantages, overcoming some of the disadvantages normally associated therewith, that may be easily and efficiently manufactured and marketed, that has a low cost of manufacture with regard to both materials and labor, and which accordingly is then susceptible of low prices of sale to the consuming public.

The described embodiment of the present invention includes a unique, new entertainment system. Two of the largest industries in entertainment are sports and music. The described embodiment of the present invention combines these two industries in a simple and user-friendly format and lets customers determine how the two are combined, thus creating seemingly infinite varieties of custom built products.

Sports video clips are little videos of highlights from sporting events. The sports video clips can be individual clips of a particular sport, or compilations of highlights. These clips are gathered and placed in a database for customers to choose and combine with their choice of music. The video clips may be accessed accruing to sport, team, year, event, etc.

Major media companies may provide video highlights that may be loaded into the database. The database may be updated daily so that the latest sports clips may be available at any time. Presentation devices (i.e., jukeboxes) may be located at casual restaurants, sports bars, college campuses, coffee shops, nightclubs, sporting arenas, high schools, and public Internet hot spots, for example. Presentation devices may also include personal digital video music players, personal data assistants, and personal computers. Distribution may be local via coaxial cables, fiber optic cables, wireless networks such as 802.11 or Bluetooth, telephone lines, the Internet, or other means. Patrons may determine the music they want to hear, and video clips they want to see, through an easy menu operation of a jukebox's user interface. The jukeboxes also include a switch to turn commentary from a video clip on or off. The jukebox has a large plasma screen to display the end product. The screen may be set to broadcast the entertainment on all other televisions in a particular establishment.

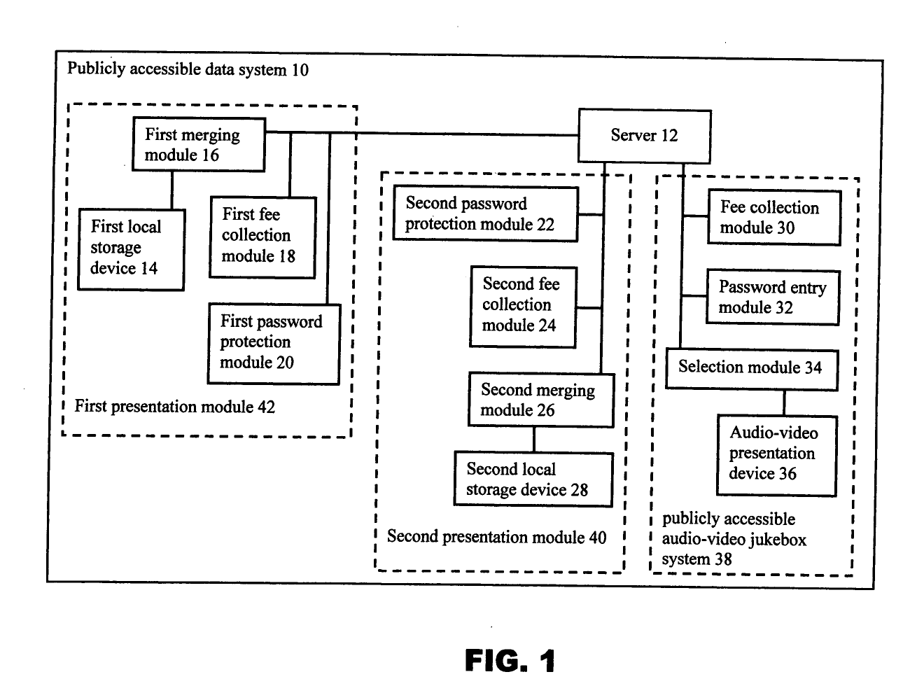

FIG. 1 is a schematic diagram depicting a publicly accessible data system 10, in accordance with an exemplary embodiment of the present invention. The publicly accessible data system 10 comprises a server 12, a first presentation module 42, a second presentation module 40, and a publicly accessible audio-video jukebox system 38. The first presentation module 42 includes a first merging module 16, a first local storage device 14, and a first fee collection module 18, among other components. The second presentation module 40 includes a second merging module 26, a second local storage device 28, and a second fee collection module 24, among other components.

A server 12 comprises audio components, video components, and photo components of the database. The audio components are stored in one or more audio folders. The audio folders are organized by audio category, the plurality of audio folders including (a) a ‘rock’ folder containing rock music, (b) a ‘country’ folder containing country music, and (c) a ‘sound effects’ folder containing sound effects. The sound effects folder contains (a) a .WAV-format audio component representing a bell; a .WAV-format audio component representing a whistle, and a .WAV-format audio component representing a prerecorded soundtrack of cheering (Note that “.WAV” is a well-known format for audio files). The audio components are suitable for editing using audio editing software, and special audio effects have been added.

The video components are contained within a plurality of video folders that are organized by video category, including (a) a ‘pre-loaded sports’ folder containing pre-loaded sports video clips, (b) a ‘local high school’ folder containing local high school video clips of a local high school including local high school year book images, and (c) a plurality of user-defined folders each containing a user-specified collection of video images. The video components are suitable for editing using video editing software, and special video effects such as stop-action, slow motion, and zoom have been added. Each component may be tagged with identifying information. For example, a video clip of a sports highlight may be tagged with names of players, type of play (pass, foul, score, blooper), and other information.

The first merging module 16 is available to the public at a public location, such as a franchise location in a shopping mall, and may superficially appear similar to a video game. Like any video game in any video arcade, the publicly accessible data system 10 includes a first fee collection module 18 that disables the first merging module 16 prior to a deposit of money, but that allows a user to use the first merging module 16 in response to the deposit of money. The second merging module 26 is implemented at a private location, for example, in a private home via the Internet or a telephone line.

The first merging module 16 is coupled to the server 12 over the Internet. If desired, the first merging module 16 is coupled to the server 12 via a dedicated telephone line or dedicated telephone lines, a fiberoptic connection, a wireless connection such as an 802.11 connection or a Bluetooth connection, or other means, or a combination of such means.

The first merging module 16 and the second merging module 26 each allows user(s) to select an audio component from the collection of audio components, a video component from the collection of video components, and/or a photo component from the collection of photo components. The first merging module 16 is operative to create a presentation file by merging the audio component if an audio component is selected, the video component if a video component is selected, and the photo component if a photo component is selected. If the presentation file has already been created, then the first merging module 16 and the second merging module 26 each allows user(s) to select an additional audio component from the collection of audio components, an additional video component from the collection of video components, and/or an additional photo component from the collection of photo components; the first merging module 16 and the second merging module 26 each allows the user(s) to append the additional audio component if an additional audio component is selected, the additional video component if a video component is selected, and the additional photo component if a photo component is selected.

When the user is satisfied with the presentation file, the user may then password-protect the presentation file using either the first password protection module 20 or the second password protection module 22. The first password protection module 20 and the second password protection module 22 each allows a user to create a read/write password and a read password. With a read/write password, the user may subsequently modify and present the presentation file. With the read password, other persons may present (but not modify) the presentation file using a publicly accessible audio-video jukebox system 38.

The first fee collection module 18, when included in the publicly accessible data system 10, enables or disables the first merging module 16. Similarly, the second fee collection module 24, when included in the publicly accessible data system 10, enables or disables the second merging module 26. The first fee collection module 18 when included, is operable to respond to a deposit of coins, currency, credit cards, and/or a deposit account that has been established ahead of time. The second fee collection module 24 when included. is operable to respond to credit cards, and/or a deposit account that has been established ahead of time. Since the second merging module 26 is located within a private location, the second fee collection module 24 uses a debit or a credit transaction. Specifically, the second fee collection module 24 uses a credit card, debit card, or other account to charge the user.

The first merging module 16 further allows a user to upload a local component from the first local storage device 14, and the second merging module 26 further allows a user to upload a local component from the second local storage device 28. The first local storage device 14 and the second local storage device 28 each contains components such as songs and music that the user has recorded or downloaded, the user's own voice providing the user's own commentary regarding a sports clip, home movies that the user has videotaped, video images from any video recording device, including hand-held video recorders as well as television video recorders, and/or a slide show or a powerpoint presentation.

In accordance with the first embodiment of the present invention, user(s) may use the first merging module 16 and/or the second merging module 26 to create the presentation file, or append to the presentation file, by copying at least one component selected from a collection of audio components, a collection of video components, and a collection of photo components. The presentation file contains the copied components. The first merging module 16 and the second merging module 26 each also allows the user(s) to upload the presentation file to the server 12. Accordingly, the server 12 contains a plurality of presentation files, each having at least one component copied from the collection of audio components, the collection of video components, and/or the collection of photo components.

In accordance with a second embodiment of the present invention, user(s) may use the first merging module 16 and/or the second merging module 26 to create the presentation file, or append to the presentation file, by generating pointers to at least one component selected from a collection of audio components, a collection of video components, and a collection of photo components. The presentation file contains a plurality of pointers, each of which identifies a selected component. Accordingly, the server 12 contains a plurality of presentation files, each having at least one pointer to a component residing within the collection of audio components, the collection of video components, and/or the collection of photo components.

The first merging module 16 has a user-defined interface. Similarly, the second merging module 26 has a user-defined interface. Accordingly, the user may select whether the user is more comfortable using a graphical user interface or a command line user interface. If the user selects the graphical user interface, then the graphical user interface represents each component on the server 12 as an icon, and the graphical user interface represents each collection of components as folders in a manner that is consistent with the Microsoft Windows desktop metaphor.

The user clicks and drags each icon representing each desired component to another icon representing the presentation file. The user may create new folders with audio components, video components and/or photo components that the user may later desire to use in other presentation files, and may drag individual video components and audio components from one such folder to another. The user may password-protect each of the new folders, using either the first password protection module 20 or the second password protection module 22. The first password protection module 20 and the second password protection module 22 each allows a user to create a read/write password and a read password. With a read/write password, the user may subsequently modify and present the presentation file, and may prohibit other users from accessing the new folders. The read/write password creates a private collection of components that the user may later desire to use in other presentation files. The private collection of components may include home movies, original music, and/or other components that the user has created and wishes to keep in privacy. With the read password, other users may copy (by dragging icons) components from the new folders to new folders of their own.

A search engine is also accessible that allows the user to search for particular components on the sever 12. If a first user has created a private collection of components using a read password, the search engine allows a second user to search within the private collection and to copy (but not delete or modify) components within the private collection. If the first user has created a private collection of components using a read/write password, then the search engine does not allow a second user to search within the private collection.

The search engine may also locate desired components by tag. It will be recalled that each component may be tagged with identifying information. For example, if a component is a video clip of a sports highlight, then the component may be tagged with names of players, type of play (pass, foul, score, blooper), and other information. The search engine allows a user to locate a desired component by the tag.

If the user selects the command line user interface, then the user may type in component identification information to identify an individual audio component and an individual video component. For example, the user may type in a name of a basketball player to search the collection of video components for video components depicting the basketball player playing basketball. The user may similarly type in a name of the basketball player to search the collection of audio components for audio components depicting the basketball player speaking. The user may type in the name or other component identifier (of an audio component or of a video component) and the audio component or video component is added to the presentation file. The user may create new folders with video components and audio components that the user may later desire to use in other presentation files, and may type in the component name or other identifier to copy a video component or an audio component from one presentation file to another.

Accordingly, a family may generate and password-protect audio-video components that include personal photographs and video components, protecting the images from unauthorized viewing, and then present the password-protected audio-video components at, for example, a family reunion.

FIG. 1 also depicts a publicly accessible audio-video jukebox system 38. The publicly accessible audio-video jukebox system 38 includes a selection module 34 that allows a user to select a presentation file from a collection of presentation files, one or more audio-video presentation devices (e.g. an audio-video presentation device 36) that are operative to present the presentation file.

The publicly accessible audio-video jukebox system 38 has a global level command file having a global playlist and a set of global rules. A cluster of audio-video presentation devices, including the audio-video presentation device 36, has a cluster level command file having a cluster playlist and a set of cluster rules. Also, each of the audio-video presentation devices, including the audio-video presentation device 36, has a local level command file having a local playlist and a set of local rules. The global level command file, cluster level command file, and local level command file control, enable, and schedule presentations of the presentation files at each of the audio-video presentation devices, including the audio-video presentation device 36.

The selection module 34 has a user interface having a plurality of windows. A first window of the user interface presents a collection of presentation files on the server 12 that the user is permitted to access. In a default state, the first window of the user interface does not present read/write password-protected presentation files. The first window also includes a password entry module 32 that allows the user to enter a password. The password entry module 32 is operative to enable the presentation file for presentation on the audio-video presentation devices (e.g. audio-video presentation device 36). If the user enters a password, the first window also presents any and all password protected presentation files for which the entered password is a read/write password. Using the user interface, the user may select one or more presentation files within the first window.

The first window also includes a search feature. In accordance with the search feature, the user may search the collection of presentation files in the first window. For example, if the presentation files presented in the first window include video clips of sports highlights, then the search feature allows the user to search the video clips by names of players, type of play (pass, foul, score, blooper), and other information. The user may search by any information contained within the tags. Accordingly, in the first window, the user may find and select presentation files including sporting events, sports highlights, rock music concerts, NASCAR events, favorite songs, home movies, and any other presentation files that have been loaded onto the server 12.

The user interface of the selection module 34 also has a second window. The second window presents the global playlist. The global playlist is an ordered list of presentation files, each identified by the order, start time, and/or countdown time it is presented.

The user may attempt to copy any of the presentation files of the first window into the global playlist of the second window. If the user desires to use a graphical user interface (the default), then the user may click on an icon in the first window that represents a desired presentation file, and the user may drag the icon into the second window. In response, the selection module 34 determines whether the user is entitled to modify the global playlist; and whether the selected presentation file (or group of presentation files) conforms to the set of global rules. If the user is entitled to modify the global playlist; and if the selected presentation file (or group of presentation files) conforms to the a set of global rules, then the selection module 34 places a copy of the selected presentation file into the global playlist. The user may select (a) play as soon as possible; (b) play at a predetermined time (and date), e.g. midnight on New Year's Eve; (c) play in a predetermined number of minutes; or (d) play in a predetermined order. A presentation file that includes “Auld Lang Syne,” for example, may be programmed to play at midnight on New Year's Eve.

If the placing of the presentation file into the global playlist creates a conflict, i.e. if two presentation files are to be presented simultaneously, then the conflict is resolved in accordance with the set of global rules. Specifically, if the user can be identified as an administrator (e.g., if the user is the owner of the establishment in which the publicly accessible audio-video jukebox system 38 is located), then the administrator wins the conflict, and any other presentation files are moved within the global playlist such that the conflict is resolved. If the user is not an administrator (e.g., if the user is a patron or customer of the establishment) then the user is given an opportunity to add additional money to win the conflict; if the user does not add sufficient additional money to win the conflict, then the user is not permitted to place the desired presentation file into the global playlist at the conflicting place within the global playlist. The user may pay to win the conflict by putting money in a fee collection module 30. The fee collection module 30 is operative (a) to disable the plurality of audio-video presentation devices (e.g. audio-video presentation device 36) prior to a deposit of money, and (b) to enable the plurality of audio-video presentation devices (e.g. audio-video presentation device 36) in response to the deposit of money.

If the user is an administrator, then the user may modify the set of global rules. The set of global rules may be set such that any changes to the set global rules are automatically incorporated into all of the sets of cluster rules and into all of the sets of local rules. If desired, the administrator may modify the set of global rules such that the set of global rules is subordinate to the set of cluster rules and to the set of local rules, (although this is probably not often to be desired). The administrator may determine how the selection module 34 resolves conflicts between the set of global rules, the set of cluster rules, and the set of local rules by setting a priority value within each of the sets of global rules, the set of cluster rules, or the set of local rules.

If the user is not an administrator, i.e. merely a patron or customer, then user is not allowed to modify the set of global rules.

The user interface of the selection module 34 also has a third window. The third window presents the cluster playlist of each cluster that is accessible from the selection module 34. The cluster playlist is an ordered list of presentation files, each identified by the order, start time, and/or countdown time it is presented.

The user may attempt to copy any of the presentation files of the first window into the cluster playlist of the third window. If the user desires to use a graphical user interface (the default), then the user may click on an icon in the first window that represents a desired presentation file, and the user may drag the icon into the third window. In response, the selection module 34 determines whether the user is entitled to modify the cluster playlist; and whether the selected presentation file (or group of presentation files) conforms to the set of cluster rules. If the user is entitled to modify the cluster playlist; and if the selected presentation file (or group of presentation files) conforms to the a set of cluster rules, then the selection module 34 places a copy of the selected presentation file into the cluster playlist. The user may select (a) play as soon as possible; (b) play at a predetermined time (and date), e.g. midnight (on New Year's Eve); (c) play in a predetermined number of minutes; or (d) play in a predetermined order. A presentation file that includes “Auld Lang Syne,” for example, may be programmed to play at midnight on New Year's Eve.

If the placing of the presentation file into the cluster playlist creates a conflict, i.e. if two presentation files are to be presented simultaneously, then the conflict is resolved in accordance with the set of cluster rules. Specifically, if the user can be identified as an administrator (e.g., if the user is the owner of the establishment in which the publicly accessible audio-video jukebox system 38 is located), then the administrator wins the conflict, and any other presentation files are moved within the cluster playlist such that the conflict is resolved. If the user is not an administrator (e.g., if the user is a patron or customer of the establishment), then the user is given an opportunity to add additional money to win the conflict; if the user does not add sufficient additional money to win the conflict, then the user is not permitted to place the desired presentation file into the cluster playlist at the conflicting place within the cluster playlist.

If the user is an administrator, then the user may modify the set of cluster rules. The set of cluster rules may be set such that any changes to the set cluster rules are automatically incorporated into all of the sets of local rules for all presentation devices within the cluster. If desired, the administrator may modify the set of cluster rules such that the set of cluster rules is subordinate to the set of local rules within the cluster (although this is probably not often to be desired). The administrator may determine how the selection module 34 resolves conflicts between the set of global rules, the set of cluster rules, and the set of local rules by setting a priority value within each of the sets of global rules, the set of cluster rules, or the set of local rules.

If the user is not an administrator, i.e. merely a patron or customer, then the user is not allowed to modify the set of cluster rules.

The user interface of the selection module 34 also has a fourth window. The fourth window presents the local playlist of each audio-video presentation device (including the audio-video presentation device 36) that is accessible from the selection module 34. The local playlist is an ordered list of presentation files, each identified by the order, start time, and/or countdown time it is presented.

The user may attempt to copy any of the presentation files of the first window into the local playlist of each audio-video presentation device 36 that is accessible in the fourth window. If the user desires to use a graphical user interface (the default), then the user may click on an icon in the first window that represents a desired presentation file, and the user may drag the icon into the fourth window. In response, the selection module 34 determines whether the user is entitled to modify the local playlist; and whether the selected presentation file (or group of presentation files) conforms to the set of local rules. If the user is entitled to modify the local playlist, and if the selected presentation file (or group of presentation files) conforms to the a set of local rules, then the selection module 34 places a copy of the selected presentation file into the local playlist. The user may select (a) play as soon as possible; (b) play at a predetermined time (and date), e.g. midnight on New Year's Eve; (c) play in a predetermined number of minutes; or (d) play in a predetermined order. A presentation file that includes “Auld Lang Syne,” for example, may be programmed to play at midnight on New Year's Eve.

If the placing of the presentation file into the local playlist creates a conflict, i.e. if two presentation files are to be presented simultaneously, then the conflict is resolved in accordance with the set of local rules. Specifically, if the user can be identified as an administrator (e.g., if the user is the owner of the establishment in which the publicly accessible audio-video jukebox system 38 is located), then the administrator wins the conflict, and any other presentation files are moved within the local playlist such that the conflict is resolved. If the user is not an administrator (e.g., if the user is a patron or customer of the establishment), then the user is given an opportunity to add additional money to win the conflict; if the user does not add sufficient additional money to win the conflict, then the user is not permitted to place the desired presentation file into the local playlist at the conflicting place within the local playlist.

If the user is an administrator, then the user may modify the set of local rules. The administrator may determine how the selection module 34 resolves conflicts between the set of global rules, the set of cluster rules, and the set of local rules by setting a priority value within each of the sets of global rules, the set of cluster rules, or the set of local rules.

If the user is not an administrator, i.e. merely a patron or customer, then the user is not allowed to modify the set of local rules.

The set of global rules, the set of cluster rules, and the set of local rules allow an administrator to determine themes. A theme may be understood as a search that the administrator requires to be performed in the first window. For example, an administrator may require that only hard rock music be played in the establishment, or that only country music be played in the establishment, or that only sports (and not home movies) be played in the establishment. The administrator may use a theme to restrict a cluster to showing only family-friendly sporting events, such as sporting events in which no player suffers an injury and music that is appropriate for children. The administrator may define a first room of the establishment as a sports room by defining a first cluster containing all the audio-video presentation devices in the first room. The administrator may then define a second room of the establishment as a country music room by defining a second cluster containing all the audio-video presentation devices in the second room. The administrator may then set the set of global rules and the set of cluster rules such that no user may violate the themes that the administrator has mandated.

Owners of bars (“administrators”) may therefore use the publicly accessible audio-video jukebox system 38 to organize an owner-specified sports presentation. For example, an owner of a sports bar may collect highlight clips of previous Superbowls, add highlight clips of the contestant teams' current season, intersperse advertisements for local businesses between the clips, and arrange for the clips and the advertisements to be presented in a predetermined order, with music and/or other audio tracks selected by the bar owner. The bar owner may program the publicly accessible audio-video jukebox system 38 to present the owner-specified sports presentation on Superbowl Sunday before the Superbowl game begins. The bar owner may also program the publicly accessible audio-video jukebox system 38 to suspend the owner-specified sports presentation whenever a customer selects (and pays for) a customer-specified sports presentation, and then to continue the owner-specified sports presentation once the customer-specified sports presentation has concluded. The bar owner may program the publicly accessible audio-video jukebox system 38 to suspend all presentations at a predetermined time, for example when the Superbowl game is about to begin.

If desired, the first presentation module 42 and the publicly accessible audio-video jukebox system 38 may be integrated. Accordingly, a user may use the first presentation module 42 to create a presentation file, and then may immediately thereafter use the publicly accessible audio-video jukebox system 38 to present the publicly accessible audio-video jukebox system 38.

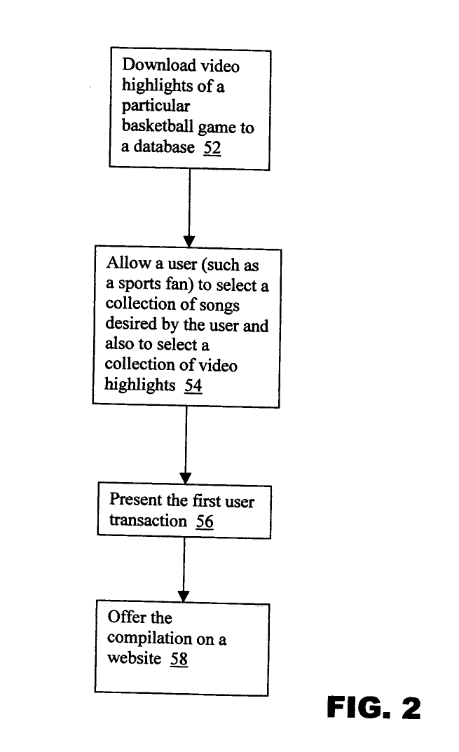

FIG. 2 is a flowchart depicting a method in accordance with a process embodiment of the present invention. It should be recalled that the method depicted in FIG. 2 is merely illustrative of a process embodiment of the present invention, and that other process embodiments may carry out the several purposes of the present invention insofar as they do not depart from the spirit and scope of the present invention.

In step 52, video highlights of a particular basketball game are downloaded to a database. For example, a sports media organization may download a folder of video highlights pertaining to each first basketball player, and a folder of video highlights pertaining to the game as a whole. The sports media organization may update folders already residing with the database, such as a folder containing all slam-dunks that have occurred during the basketball season, or a folder containing all fouls that have occurred during the basketball season. Other folders that may be updated include a folder of all-time-greatest-plays and a folder of all players who have attended a particular university. Within step 52, each video highlight is flagged with identifying information. For example, the identifying information includes the names of all players involved, the type of play (steal, dunk, foul, pass), and the game status (i.e., post season or regular season). The sports highlights may be described as video components. The database already contains songs, which may be described as audio components.

In step 54, representing a first user transaction, a merging module allows a user (such as a sports fan) to select a collection of songs desired by the user and also to select a collection of video highlights. Step 54 effectively creates a presentation file. The songs and the video highlights that the user selects are placed in a folder corresponding to the first user transaction. The user transaction may be identified by a user name, code name, or transaction number. The selected video components and audio components may be organized into an order. Collectively, the selected video components and audio components may be regarded as an audio-video presentation. Since each video clip and each song may be brief (video clips may only be of a few seconds duration, and songs may be only a few minutes), the user may select multiple video clips and songs.

Step 54 may also include a query, such that the video clips and the folders within the database may be searched. For example, a keyword search may be performed on all of the identifying information associated with the various video highlights. Similarly, songs may be searched for identifying information. Accordingly, a fan may search the database for songs having a particular beat, or songs that mention a particular city, or songs that mention a particular sport or other keyword. Step 54 may also include password protection. Accordingly, the user may password protect the first user transaction.

In step 56, the presentation file of the first user transaction is presented. For example, the presentation file of the first user transaction may be presented at a jukebox. The presentation file of the first user transaction may begin immediately, or may be delayed until previously entered user transactions are concluded. In a large bar or restaurant, multiple users may select multiple user transactions, and the multiple user transactions may be presented in the order in which they were selected. If desired, a bar owner may also select user transactions that have a lower priority, and that are presented only when no customer has selected a user transaction. If desired, a user transaction may be postponed until a predetermined time and/or date.

If desired, step 56 may include a presentation of a compilation copyright. Accordingly, reproduction and redistribution of the compilation may be controlled either by the user or by the bar owner. The compilation may be available for sale. If desired, step 56 may also include a deposit of money into a money collection device. Money collected may be provided to a copyright holder or licensee.

In step 58, the compilation is offered on a website. The website may be an e-commerce website that offers the compilation for sale. The website may include a one-time presentation fee, and/or a limitless use fee, or no fee. If the compilation is password-protected, then one fee may be applicable to customers who know the password, and another fee may be applicable to customers who do not know the password. The website may also include a weblog for other fans to provide comments, or to offer similar (or dissimilar) compilations for sale. Distribution may be central-server based, or may be peer-to-peer.

While a preferred embodiment of the publicly accessible data method, apparatus and system for electronically distributing performances has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, a data storage device such as a hard drive may be used instead of the server 12, the first local storage device 14, or the second local storage device 28 described above, and any data transmission device (including physical transportation of mass storage devices) may be used instead of the Internet or telephone lines or wireless network described above. Similarly, the sports clips may be replaced by a family's home movies to the database, confident that its home movies are protected by the password protection module.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

In view of the foregoing, it will be understood by those skilled in the art that the methods of the present invention can facilitate electronic distribution of performances, and in particular a publicly accessible data method, apparatus and system for electronically distributing performances. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A publicly accessible data system comprising:
on a server, a database of components that are audio, video, and/or photo;
a merging module that allows a user to create and/or modify a presentation file suitable for presentation at a publicly accessible audio-video jukebox system, the presentation file being a subset of the components, the presentation file having at least two components that are selected from a group consisting of audio, video, and photo, and that have been merged into the presentation file, the presentation file residing on the server;
a presentation device that presents the presentation file from the server such that the presentation file is presented to the user.

2. The publicly accessible data system of claim 1, wherein the merging module is operative to append at least one of the components to an existing presentation file.

3. The publicly accessible data system of claim 1, further comprising a password module operative to password-protect the presentation file.

4. The publicly accessible data system of claim 1, wherein the merging module is available to the public at a public location.

5. The publicly accessible data system of claim 1, wherein the merging module is available over the Internet.

6. The publicly accessible data system of claim 1, further comprising a fee collection module operative (a) to disable the merging module prior to a deposit of money, and (b) to enable the merging module in response to the deposit of money.

7. The publicly accessible data system of claim 1, further comprising a graphical user interface operative to allow a user to control the merging module.

8. The publicly accessible data system of claim 1, further comprising a command line user interface operative to allow a user to control the merging module.

9. The publicly accessible data system of claim 1, further comprising a delivery module operative to deliver the presentation file to a remote location for public presentation.

10. The publicly accessible data system of claim 1, wherein the audio selection module comprises a plurality of audio folders organized by audio category, the plurality of audio folders including (a) a ‘rock’ folder containing rock music, (b) a ‘country’ folder containing country music, and (c) a ‘sound effects’ folder containing sound effects.

11. The publicly accessible data system of claim 1, wherein the video selection module comprises a plurality of video folders organized by video category, the plurality of video folders including (a) a ‘pre-loaded sports’ folder containing pre-loaded sports video clips, (b) a ‘local high school’ folder containing local high school video clips of a local high school including local high school year book images, and (c) a plurality of user-defined folders each containing a user-specified collection of video images.

12. The publicly accessible data system of claim 11, further comprising a user upload module operative to allow a user to upload the user-specified collection of video images to the publicly accessible data system.

13. An audio-video jukebox system comprising:
a selection module operative to allow a user to select a presentation file from a collection of presentation files;
a plurality of audio-video presentation devices (e.g. audio-video presentation device 36) operative to present the presentation file; and
a fee collection module operative (a) to disable the plurality of audio-video presentation devices (e.g. audio-video presentation device 36) prior to a deposit of money, and (b) to enable the plurality of audio-video presentation devices (e.g. audio-video presentation device 36) in response to the deposit of money.

14. The audio-video jukebox system of claim 13, further comprising a password entry module operative to enable the presentation file for presentation on the audio-video presentation devices (e.g. audio-video presentation device 36).

15. The audio-video jukebox system of claim 13, further comprising a graphical user interface operative to allow a user to select the presentation file from the collection of presentation files.

16. The audio-video jukebox system of claim 13, further comprising a command line user interface operative to allow a user to select the presentation file from the collection of presentation files.

17. The audio-video jukebox system of claim 13, wherein the selection module comprises a query module operative to search a database for the presentation file in response to command from the user.

18. The audio-video jukebox system of claim 17, further comprising a local data storage module operative to store the database within the audio-video jukebox system.

19. The audio-video jukebox system of claim 17, wherein the query module is operative to generate a query to the database wherein at least a portion of the database is not within the audio-video jukebox system.

20. The audio-video jukebox system of claim 17, further comprising a management filter operative to enable a theme folder such that the presentation file may only be presented when the presentation file is of the theme folder.

21. The audio-video jukebox system of claim 20, wherein the theme folder comprises rock music, such that the presentation file may only be presented when the presentation file contains rock music.

22. The audio-video jukebox system of claim 21, further comprising a management filter operative to disable a theme folder such that the presentation file may be not presented when the presentation file is of the theme folder.
